(19) United States
(12) Patent Application Publication
(10) Pub. No.: US 2015/0305386 A1
(43) Pub. Date: Oct. 29, 2015

(54) COMPOSITIONS FOR NUTRITIONAL SUPPLEMENTATION

(71) Applicants: Eduardo Fernandez, Hoboken, NJ (US); Charles Balzer, Chatham, NJ (US)

(72) Inventors: Eduardo Fernandez, Hoboken, NJ (US); Charles Balzer, Chatham, NJ (US)

(21) Appl. No.: 14/263,829

(22) Filed: Apr. 28, 2014

(51) Int. Cl. A23L 1/303; A23L 1/304

(52) U.S. Cl. CPC A23L 1/303; A23L 1/304

(57) ABSTRACT

Compositions for nutritional supplementation and methods for administering such compositions are disclosed. These compositions provide greater patient compliance. These compositions can be used to administer one or more vitamins, minerals, or trace elements.

### FIELD OF THE INVENTION

Disclosed herein are various vitamin, nutrient, and mineral compositions and kits for nutritional supplementation and methods of administration of compositions and kits for nutritional supplementation.

### BACKGROUND OF THE INVENTION

Supplementation with certain vitamins and minerals serves a role in protecting against disease and contributes to the overall health of a mother and developing child. Vitamins, nutrients, and minerals, such as vitamin B₆, vitamin B₉, and vitamin B₁₂, play integral roles in physiological mechanisms that serve to prevent, treat, and/or alleviate the occurrence or negative effects of some diseases.

Supplemental iron is extremely important during pregnancy due to the large increase in blood plasma volume and erythropoetic (red blood cell production) activity. Anemia is common in pregnancy, notably in the absence of supplemental iron consumption. Negative outcomes of pregnancy have been correlated with an iron-specific anemic state during pregnancy.

Iodine plays an important role in fetal brain and cognitive development. Studies have demonstrated moderately low systemic levels of iodine in women of childbearing age. Low iodine may be due to a general decrease in seafood secondary for fear of seaborne contaminants.

Vitamin D has been shown to have positive effects on the immune system, including during pregnancy. However, epidemiologic studies have demonstrated that a large percentage of pregnant women, including those of childbearing age, possess systemically insufficient levels of vitamin D.

Patient compliance is a problem with conventional, commercially available nutritional supplements, including prenatal vitamins, which typically have a relatively large weights and/or volumes, e.g., weights of around 800 mg and volumes of around 0.700 cm³. For example, problems with compliance are sometimes seen when pregnant women have a condition that does not allow them to easily take current commercially available prenatal vitamins, including morning sickness or nausea and vomiting of pregnancy. Indeed, it is estimated that 50% of the population has problems swallowing such conventional dosage forms. Seger, 50 J. PHARM. PHARMACOL. 375-82 (1998). These problems can lead to poor compliance, or even noncompliance, with dosing regimens and thus have negative impacts on treatment efficiency.

Accordingly, a need exists for compositions that provide suitable nutritional supplementation and that maximize patient compliance. Such compositions may be used, for example, before, during, and after pregnancy.

### SUMMARY OF THE INVENTION

Disclosed herein are compositions and kits for nutritional supplementation and methods for providing nutritional supplementation to a patient by administering such compositions and kits. In some embodiments, the disclosed methods, compositions, and kits for nutritional supplementation may provide improved patient compliance compared to other compositions for nutritional supplementation. In some embodiments, the disclosed methods, compositions, and kits for nutritional supplementation can be used to administer one or more vitamins, minerals, or trace elements. In some embodiments, the compositions and kits for nutritional supplementation disclosed herein may be a prenatal vitamin. In some embodiments, the compositions and kits for nutritional supplementation disclosed herein may be a dietary supplement.

Some embodiments herein provide for compositions for nutritional supplementation that may comprise vitamin B₉, vitamin B₁₂, vitamin B₆, vitamin D, iodine, and iron. In some embodiments, the compositions may comprise about 0.5 mg to about 1.5 mg vitamin B₉, about 6 μg to about 18 μg vitamin B₁₂, about 1.2 mg to about 3.8 mg vitamin B₆, about 500 IU to about 1500 IU vitamin D, about 75 μg to about 225 μg iodine, and about 9 mg to about 27 mg iron. In some embodiments, the compositions may comprise about 1 mg vitamin B₉, about 12 μg vitamin B₁₂, about 2.5 mg vitamin B₆, about 1000 IU vitamin D, about 150 μg iodine, and about 18 mg iron. In some embodiments, the compositions may comprise at least about 1 mg vitamin B₉, at least about 12 μg vitamin B₁₂, at least about 2.5 mg vitamin B₆, at least about 1000 IU vitamin D, at least about 150 μg iodine, and at least about 18 mg iron.

In some embodiments, the composition may comprise at least one inactive ingredient. In some embodiments, the at least one inactive ingredient may be a sweetener. In some embodiments, the composition may be a tablet. In some embodiments, the tablet may be a coated tablet.

In some embodiments, the composition may have a weight of about 70 mg to about 210 mg. In some embodiments, the composition may have a weight of about 100 mg to about 180 mg. In some embodiments, the composition may have a weight of about 140 mg. In some embodiments, the composition may have a weight of about 145 mg. In some embodiments, the composition may have a volume of about 0.2 cm³ to about 0.7 cm³. In some embodiments, the composition may have a volume of about 0.5 cm³. In some embodiments, the composition may have a volume of less than about 0.5 cm³. In some embodiments, the composition may have a volume of about 0.150 cm³ to about 0.050 cm³. In some embodiments, the composition may have a volume of about 0.105 cm³. In some embodiments, the composition may have a volume of less than about 0.105 cm³.

In some embodiments, the composition or kit disclosed herein may be administered to a patient, wherein the patient may be a pregnant woman, prenatal woman, or a woman who is breast-feeding. In some embodiments, the composition or kit disclosed herein may be administered to a patient, wherein the composition or kit disclosed herein is administered before, during, and after the patient's pregnancy. In some embodiments, the composition or kit disclosed herein may be administered to a patient once a day, twice a day, three times a day, four times a day, or five times a day. In some embodiments, the composition or kit disclosed herein may be administered to a patient once daily. In some embodiments, the composition or kit disclosed herein may be administered to a patient as directed by a physician. In some embodiments, the composition or kit disclosed herein may have improved patient compliance. In some embodiments, the reduced weight and/or volume of the composition may improve patient compliance.

Some embodiments herein may provide for methods for providing nutritional supplementation to a patient, wherein the method may comprise administering a composition to the patient, wherein the composition may comprise vitamin B₉, vitamin B₁₂, vitamin B₆, vitamin D, iodine, and iron.

In some embodiments, the method may comprise administering a composition to the patient, wherein the composition may comprise about 0.5 mg to about 1.5 mg vitamin B₉, about 6 μg to about 18 μg vitamin B₁₂, about 1.2 mg to about 3.8 mg vitamin B₆, about 500 IU to about 1500 IU vitamin D, about 75 μg to about 225 μg iodine, and about 9 mg to about 27 mg iron. In some embodiments, the method may comprise administering a composition to the patient, wherein the composition may comprise about 1 mg vitamin B₉, about 12 μg vitamin B₁₂, about 2.5 mg vitamin B₆, about 1000 IU vitamin D, about 150 μg iodine, and about 18 mg iron. In some embodiments, the method may comprise administering a composition to the patient, wherein the composition may comprise at least about 1 mg vitamin B₉, at least about 12 μg vitamin B₁₂, at least about 2.5 mg vitamin B₆, at least about 1000 IU vitamin D, at least about 150 μg iodine, and at least about 18 mg iron.

In some embodiments, the method may comprise administering a composition to the patient, wherein the composition may comprise at least one inactive ingredient. In such embodiments, the at least one inactive ingredient may be a sweetener. In some embodiments, the method may comprise administering a composition to the patient, wherein the composition may be a tablet. In some embodiments, the tablet may be a coated tablet.

In some embodiments, the method may comprise administering a composition to the patient, wherein the composition may have a weight of about 70 mg to about 210 mg. In some embodiments, the method may comprise administering a composition to the patient, wherein the composition may have a weight of about 100 mg to about 180 mg. In some embodiments, the method may comprise administering a composition to the patient, wherein the composition may have a weight about 140 mg. In some embodiments, the method may comprise administering a composition to the patient, wherein the composition may have a weight about 145 mg. In some embodiments, the method may comprise administering a composition to the patient, wherein the composition may have a volume of about 0.2 cm³ to about 0.7 cm³. In some embodiments, the method may comprise administering a composition to the patient, wherein the composition may have a volume of about 0.150 cm³ to about 0.050 cm³. In some embodiments, method may comprise administering a composition to the patient, wherein the composition may have a volume of about 0.5 cm³. In some embodiments, method may comprise administering a composition to the patient, wherein the composition may have a volume of less than about 0.5 cm³. In some embodiments, the method may comprise administering a composition to the patient, wherein the composition may have a volume of about 0.105 cm³. In some embodiments, the method may comprise administering a composition to the patient, wherein the composition may have a volume of less than about 0.105 cm³.

In some embodiments, the method may comprise administering a composition or kit disclosed herein to a patient, wherein the composition or kit administered to the patient may have improved patient compliance. In some embodiments, method may comprise administering a composition or kit disclosed herein to a patient, wherein the reduced weight and/or volume of the composition may improve patient compliance. In some embodiments, the method may comprise administering a composition or kit disclosed herein to a patient, wherein the patient may be a pregnant woman, prenatal woman, or a woman who is breast-feeding. In some embodiments, the method may comprise administering a composition or kit disclosed herein to a patient, wherein the composition or kit is administered before, during, and after the patient's pregnancy. In some embodiments, the method may comprise administering a composition or kit disclosed herein to a patient, wherein the composition or kit may be administered to a patient as directed by a physician. In some embodiments, the method may comprise administering a composition or kit disclosed herein to the patient once a day, twice a day, three times a day, four times a day, or five times a day. In some embodiments, the method may comprise administering a composition or kit disclosed herein to a patient, wherein the composition or kit may be administered to a patient once daily.

### DETAILED DESCRIPTION OF THE INVENTION

It is understood that this disclosure is not limited to the particular methodologies, protocols, fillers, and excipients, etc., described herein, as these may vary. It is also to be understood that the terminology used herein is used for the purpose of describing particular embodiments only, and is not intended to limit the scope of the disclosed invention. It must be noted that as used herein and in the appended claims, the singular forms “a,” “an,” and “the” include the plural reference unless the context clearly dictates otherwise. Thus, for example, a reference to “a vitamin” is a reference to one or more vitamins and includes equivalents thereof known to those skilled in the art and so forth.

Unless defined otherwise, all technical and scientific terms used herein have the same meanings as commonly understood by one of ordinary skill in the art to which this invention belongs. Specific methods, devices, and materials are described, although any methods and materials similar or equivalent to those described herein can be used in the practice or testing of the disclosed invention. All references cited herein are incorporated by reference herein in their entirety.

As used herein, the term “patient” comprises any and all organisms and includes the term “subject.” “Patient” may refer to a human, a female human, or any other animal.

As used herein, the term “administered” or “administering” refers to the act of giving a composition to a patient or otherwise making such composition available to a patient or the patient taking a composition. The phrase “co-administration” refers to administration of two or more compositions to a patient together, which includes administration at about the same time or within a certain specific or desired time.

As used herein, the term “about,” when located before a dosage amount or dosage range of a specific ingredient, refers to an amount or range above and/or below the stated amount or ranges that does not manifestly alter the therapeutic effect of the specific ingredient from the stated amount or range and is meant to encompass at least all functional equivalents of that amount.

As used herein, the term “dosage form” is the form in which the dose is to be administered to the subject or patient.

As used herein, the terms “inactive,” “inert,” “excipient,” and/or “formulatory” refer to any compound that is an inactive ingredient of a described composition. The definition of “inactive ingredient” as used herein follows that of the U.S. Food and Drug Administration, as defined in 21 C.F.R. §201.3(b)(8), which is any component of a drug product other than the active ingredient. By “active ingredient,” then, is meant any compound intended to furnish pharmacological activity or other direct effect in the diagnosis, cure, mitigation, treatment and/or prevention of a condition. See 21 C.F.R. §210.3(b)(7). Further, “active ingredients” include those compounds of the composition that may undergo chemical change during the manufacture of the composition and be present in the final composition in a modified form intended to furnish an activity or effect. Id. These may include the vitamins, minerals, and nutrients of the compositions disclosed herein. Indeed, the term “inactive ingredients” includes ingredients—such as, and only by way of example, dicalcium phosphate—that may be considered an active ingredient in another setting or composition, but that are intended to serve no therapeutic or nutritional purpose in the compositions disclosed herein.

In some embodiments, the active ingredients, such as the vitamins, minerals, and nutrients of the disclosed invention, may be included in overages. Adding overages of these compounds may be necessary to meet the amounts claimed on the product label and product insert to ensure that those recited amounts are met throughout the shelf life of the product. Indeed, because of U.S. regulatory requirements that label values reflect minimum contents of these nutrients, deviations in actual nutrient content from label values are usually thought to tend toward overages. See Dwyer et al., ANAL BIOANAL CHEM, 389:37-45 (2007). In some embodiments, one or more of the vitamins, minerals, and nutrients may be included in the compositions, kits, and methods disclosed herein in overages of the recited, specific label amounts, for example, of about 100% to about 150% of the label amount, although the overages may be dependent on the stability of each ingredient. For example, overages of vitamin D and vitamin B₁₂ may be necessary due to the lack of stability of specific forms. In another example, 5-methyl-tetrahydrofolate, a form of vitamin B₉, is degraded by light, temperature and may degrade during processing and storage. Overages may be larger for some vitamins particularly those that are less stable and more likely to deteriorate with a long shelf life, those that have other functions (such as antioxidants) in the product itself; for minerals, excess amounts with larger overages are probably less likely because of their increased bulk and shelf life stability. Id. Accordingly, when overages are included for any specific active ingredient, at some point in time, these ingredients with overages may degrade so that they fall within the amounts provided in the specific label. Thus, there is no literal difference between the amounts for active ingredients that include overages, and those amounts listed on the specific label. Furthermore, overages provide an equivalent efficacy of the active ingredient over the shelf life of the product. Accordingly, an active ingredient provided in overage amounts in the methods, compositions, and kits disclosed herein is an insubstantial change in comparison to the specific label amount and performs substantially the same function, in substantially the same way, and leads to substantially the same result as the same active ingredient in the amounts as provided on the specific label.

In some embodiments of the compositions, kits, and methods disclosed herein, vitamin B₆ may be included. In some embodiments, vitamin B₆ may be included in the forms of pyridoxine, 3-hydroxy-4,5-bis(hydroxymethyl)2-methylpyridine, 5′-deoxypyridoxal, 2-demethylpyridoxal(2-norpyridoxal), 2-propyl-2-norpyridoxal (2′-ethylpyridoxal), 6-methylpyridoxal, 2′-hydroxypyridoxal (2-hydroxymethyl-2-demethylpyridoxal or 2-hydroxymethyl-2-norpyridoxal), 4′-deoxypyridoxine 5′-phosphate, 5′-methylpyridoxal-5′-phosphate, pyridoxal N-oxide 5′-phosphate, Pyridoxal, Pyridoxamine, Pyridoxine-5′-phosphate (PNP), pyridoxal-5′-phosphate (PLP) and pyridoxamine-5′-phosphate (PMP), and salts and chelates thereof. In a specific embodiment, vitamin B₆ may be included in the form of pyridoxine hydrochloride.

In some embodiments of the compositions, kits, and methods disclosed herein, vitamin B₆ may be included in an amount ranging from about 1.2 mg to about 3.8 mg. In some embodiments, vitamin B₆ may be included in an amount ranging from about 1.5 mg to about 3.5 mg. In some embodiments, vitamin B₆ may be included in an amount ranging from about 2 mg to about 3 mg. In some embodiments, vitamin B₆ may be included in an amount of about 1.2 mg, about 1.3 mg, about 1.4 mg, about 1.5 mg, about 1.6 mg, about 1.7 mg, about 1.8 mg, about 1.9 mg, about 2 mg, about 2.1 mg, about 2.2 mg, about 2.3 mg, about 2.4 mg, about 2.5 mg, about 2.6 mg, about 2.7 mg, about 2.8 mg, about 2.9 mg, about 3 mg, about 3.1 mg, about 3.2 mg, about 3.3 mg, about 3.4 mg, about 3.5 mg, about 3.6 mg, about 3.7 mg, or about 3.8 mg. In some embodiments, vitamin B₆ may be included in an amount of at least about 1.2 mg, at least about 1.3 mg, at least about 1.4 mg, at least about 1.5 mg, at least about 1.6 mg, at least about 1.7 mg, at least about 1.8 mg, at least about 1.9 mg, at least about 2 mg, at least about 2.1 mg, at least about 2.2 mg, at least about 2.3 mg, at least about 2.4 mg, at least about 2.5 mg, at least about 2.6 mg, at least about 2.7 mg, at least about 2.8 mg, at least about 2.9 mg, at least about 3 mg, at least about 3.1 mg, at least about 3.2 mg, at least about 3.3 mg, at least about 3.4 mg, at least about 3.5 mg, at least about 3.6 mg, at least about 3.7 mg, or at least about 3.8 mg. In some embodiments of the compositions, kits, and methods disclosed herein, vitamin B₆ may be included in an overage amount of up to about 125% of the specified label amount.

In some embodiments, vitamin B₆ may be included in specific ranges or amounts for each specific form. When provided in their specific forms, the provided numerical range or amount includes the amounts of the specific form and/or compounds that are equivalent to the specific form. For example, vitamin B₆ may be in the form of pyridoxine hydrochloride and may be included in the amount of about 2.5 mg. Accordingly, in this example, “pyridoxine hydrochloride in the amount of about 2.5 mg” would include 2.5 mg of pyridoxine hydrochloride and/or its equivalents and would, for example, include a product having 2.5 mg pyridoxamine instead of pyridoxine hydrochloride, as well as intended overages of vitamin B₆, in any form.

In some embodiments of the compositions, kits, and methods disclosed herein, vitamin B₉ may be included. Vitamin B₉ is a generic name of a B-vitamin that includes multiple compounds with a general structure. For example, vitamin B₉ encompasses the term folate, which itself is the generic name for many different forms of this water-soluble vitamins. Indeed, folate encompasses numerous compounds that, for example, are based on a pteridine ring, an aminobenzoic acid and one or more glutamic acid residues. Folic acid (pteroglutamic acid or PGA) is a synthetic form of folate, and the first folate synthesized and used as a supplement. The term folates may also be used in the generic sense to designate any members of the family of pteroylglutamates, or mixtures of them, having various levels of reduction of the pteridine ring, one-carbon substitutions and numbers of glutamate residues. Accordingly, vitamin B₉ is not exclusively defined by its structure, but also by its various functions, which include DNA synthesis, cell division, and as a coenzyme in one-carbon transfer reactions.

Thus, as used herein, vitamin B₉ may include numerous forms. In a specific embodiment, vitamin B₉ may be included in the form of folic acid. In some embodiments, vitamin B₉ may be folic acid USP (i.e., folic acid that conforms to the applicable specifications of United States Pharmacopeia (“USP”)). In other embodiments, vitamin B₉ may be included one or more of the forms of folic acid, folacin, Metafolin® (Merck KGaA, Darmstadt, Germany) (also known as the calcium salt of L-5-methyl-tetrahydrofolic acid), folate and/or one or more natural isomers of folate including (6S)-tetrahydrofolic acid or a polyglutamyl derivative thereof, 5-methyl-(6S)-tetrahydrofolic acid or a polyglutamyl derivative thereof, 5-formyl-(6S)-tetrahydrofolic acid or a polyglutamyl derivative thereof, 10-formyl-(6R)-tetrahydrofolic acid or a polyglutamyl derivative thereof, 5,10-methylene-(6R)-tetrahydrofolic acid or a polyglutamyl derivative thereof, 5,10-methenyl-(6R)-tetrahydrofolic acid or a polyglutamyl derivative thereof and 5-formimino-(6S)-tetrahydrofolic acid or a polyglutamyl derivative thereof and the salts and esters thereof. In another embodiment, vitamin B₉ may be in the form of a folate or folate derivative thereof that is eventually converted to 5-methyl-tetrahydrofolic acid in the body and/or is absorbed into the bloodstream as 5-methyl-tetrahydrofolic acid. Folates, such as folic acid and folate, are eventually absorbed in the body and converted to L-5-methyl-tetrahydrofolic acid. In another embodiment, vitamin B₉ may be in the form of a folate or folate derivative thereof that increases blood folate levels, thereby reducing homocysteine levels.

In another embodiment, vitamin B₉ may be in the form of folate or reduced folates with various salts. In a specific embodiment, the folate and reduced folate are selected from the group consisting of D-glucosamine-folate, D-galactosamine-folate, D-glucosamine (6R,S)-tetrahydrofolate, D-glucosamine (6S)-tetrahydrofolate, D-glucosamine (6R)-tetrahydrofolate; D-galactosamine (6R,S)-tetrahydrofolate, D-galactosamine (6S)-tetrahydrofolate, D-galactosamine (6R)-tetrahydrofolate; D-glucosamine 5-methyl-(6R,S)-tetrahydrofolate, D-glucosamine 5-methyl-(6S)-tetrahydrofolate, D-glucosamine 5-methyl-(6R)-tetrahydrofolate; D-galactosamine 5-methyl-(6R,S)-tetrahydrofolate, D-galactosamine 5-methyl-(6S)-tetrahydrofolate, and D-galactosamine 5-methyl-(6R)-tetrahydrofolate. In some embodiments, vitamin B₉ may folic acid, a calcium salt of L-5-methyl-tetrahydrofolic acid, or a combination thereof. In some embodiments, vitamin B₉ may be a combination of folic acid and a calcium salt of L-5-methyl-tetrahydrofolic acid. In some embodiments, the ratio of the amount of folic acid to the amount of calcium salt of L-5-methyl-tetrahydrofolic acid may be about 1:1, about 2:3, or about 3:7.

In some embodiments of the compositions, kits, and methods disclosed herein, vitamin B₉ may be included in an amount ranging from about 0.5 mg to about 1.5 mg. In some embodiments, vitamin B₉ may be included in an amount ranging from about 0.8 mg to about 1.2 mg. In some embodiments, vitamin B₉ may be included in an amount ranging from about 0.9 mg to about 1.1 mg. In certain specific embodiments, vitamin B₉ may be included in an amount of about 0.5 mg, about 0.6 mg, about 0.7 mg, about 0.8 mg, about 0.9 mg, about 1.0 mg, about 1.1 mg, about 1.2 mg, about 1.3 mg, about 1.4 mg, or about 1.5 mg. In certain specific embodiments, vitamin B₉ may be included in an amount of at least about 0.5 mg, at least about 0.6 mg, at least about 0.7 mg, at least about 0.8 mg, at least about 0.9 mg, at least about 1.0 mg, at least about 1.1 mg, at least about 1.2 mg, at least about 1.3 mg, at least about 1.4 mg, or at least about 1.5 mg. In some embodiments of the compositions, kits, and methods disclosed herein, vitamin B₉ may be included in an overage amount of up to about 140% of the specified label amount.

In some embodiments, vitamin B₉ may be included in specific ranges or amounts for each specific form. When provided in their specific forms, the provided numerical range or amount includes the amounts of the specific form and/or compounds that are equivalent to the specific form. For example, vitamin B₉ may be in the form folic acid and may be included in the amount of about 1 mg. Accordingly, in this example, “folic acid in the amount of about 1 mg” would include 1 mg of folic acid and/or its equivalents and would, for example, include a product having 1 mg 5-methyl-(6S)-tetrahydrofolic acid instead of folic acid, as well as intended overages of vitamin B₉, in any form.

In some embodiments of the compositions, kits, and methods disclosed herein, vitamin B₁₂ may be included. Vitamin B₁₂ can be converted to the active coenzymes methylcobalamin and 5′-deoxyadenosylcobalamin. In certain embodiments, vitamin B₁₂ may be in one or more of the forms of cobalamin, methylcobalamin, 5′-deoxyadenosylcobalamin (adenosylcobalamin or cobamamide), cyanocobalamin, hydroxycobalamin and mecobalamin. In some embodiments, vitamin B₁₂ may be cyanocobalamin. In some embodiments, vitamin B₁₂ may be cobalamin.

In some embodiments of the compositions, kits, and methods disclosed herein, vitamin B₁₂ may be included in an amount ranging from about 6 μg to about 18 μg. In some embodiments, vitamin B₁₂ may be included in an amount ranging from about 9 μg to about 15 μg. In some embodiments, vitamin B₁₂ may be included in an amount ranging from about 11 μg to about 13 μg. In certain specific embodiments, vitamin B₁₂ may be included in an amount of about 6 μg, about 7 μg, about 8 μg, about 9 μg, about 10 μg, about 11 μg, about 12 μg, about 13 μg, about 14 μg, about 15 μg, about 16 μg, about 17 μg, or about 18 μg. In certain specific embodiments, vitamin B₁₂ may be included in an amount of at least about 6 μg, at least about 7 μg, at least about 8 μg, at least about 9 μg, at least about 10 μg, at least about 11 μg, at least about 12 μg, at least about 13 μg, at least about 14 μg, at least about 15 μg, at least about 16 μg, at least about 17 μg, or at least about 18 μg. In some embodiments of the compositions, kits, and methods disclosed herein, vitamin B₁₂ may be included in an overage amount of up to about 140% of the specified label amount.

In some embodiments, vitamin B₁₂ may be included in specific ranges or amounts for each specific form. When provided in their specific forms, the provided numerical range or amount includes the amounts of the specific form and/or compounds that are equivalent to the specific form. For example, vitamin B₁₂ may be in the form cyanocobalamin and may be included in the amount of about 12 μg. Accordingly, in this example, “cyanocobalamin in the amount of about 12 μg” would include about 12 μg of cyanocobalamin and/or its equivalents and would, for example, include a product having about 12 μg methylcobalamin instead of cyanocobalamin, as well as intended overages of vitamin B₁₂, in any form.

In some embodiments of the compositions, kits, and methods disclosed herein, vitamin D may be included. In certain embodiments, vitamin D may be in one or more of the forms of vitamin D₃ (also known as calciol or cholecalciferol or colecalciferol), vitamin D₂ (also known as calciferol, ergocalciol, ergocalciferol, ercalciol, Deltalin or Viosterol), previtamin D2, ergosterol, calcitriol (also known as 1,25-dihydroxycholecalciferol), 7-dehydrocholesterol, vitamin D₁, vitamin D₄ (also known as 22-dihydroergocalciferol, 22,23-dihydroercalciol or (24S)-methylcalciol), vitamin D₅ (also known as (24S)-Ethylcalciol or sitocalciferol), 7-dehydrositosterol, Lumisterol, 25-hydroxyvitamin D, all steroids that exhibit the biological activity of calciol, 25-fluorocalciol, (3S)-3-amino-3-deoxycalciol, 11α-acetoxycalciol, calcidiol (also known as 25-hydroxycholecalciferol or calcifediol), ercalcitriol, calcitetrol, tacalciol (also known as tachysterol3), (5E)-isocalciol (also known as isovitamin D₃), Dihydroercalciol (also known as dihydrotachysterol3), (1S)-Hydroxycalciol (also known as 1α-hydroxycholecalciferol or alfacaleidol), (24R)-Hydroxycalcidiol (also known as 24(R),25-dihydroxycholecalciferol), Ercalcidiol, Ercalcitriol, Ertacalciol, (5E)-(10S)-10,19-Dihydroercalciol (also known as dihydrotachysterol 2), (6Z)-Tacalciol (also known as precalciferol or pre-vitamin D), and (22E)-(24R)-Ethyl-22,23-didehydrocalciol also known as vitamin D₆. In some embodiments, vitamin D may be cholecalciferol.

In some embodiments of the compositions, kits, and methods disclosed herein, vitamin D may be included in an amount ranging from about 500 IU to about 1500 IU. In some embodiments, vitamin D may be included in an amount ranging from about 800 IU to about 1200 IU. In some embodiments, vitamin D may be included in an amount ranging from about 900 IU to about 1100 IU. In certain specific embodiments, vitamin D may be included in an amount of about 900 IU, about 910 IU, about 920 IU, about 930 IU, about 940 IU, about 950 IU, about 960 IU, about 970 IU, about 980 IU, about 990 IU, about 1000 IU, about 1010 IU, about 1020 IU, about 1030 IU, about 1040 IU, about 1050 IU, about 1060 IU, about 1070 IU, about 1080 IU, about 1090 IU, about 1000 IU, or about 1100 IU. In certain specific embodiments, vitamin D may be included in an amount of at least about 900 IU, at least about 910 IU, at least about 920 IU, at least about 930 IU, at least about 940 IU, at least about 950 IU, at least about 960 IU, at least about 970 IU, at least about 980 IU, at least about 990 IU, at least about 1000 IU, at least about 1010 IU, at least about 1020 IU, at least about 1030 IU, at least about 1040 IU, at least about 1050 IU, at least about 1060 IU, at least about 1070 IU, at least about 1080 IU, at least about 1090 IU, at least about 1000 IU, or at least about 1100 IU. In some embodiments of the compositions, kits, and methods disclosed herein, vitamin D may be included in an overage amount of up to about 140% of the specified label amount.

In some embodiments, vitamin D may be included in specific ranges or amounts for each specific form. When provided in their specific forms, the provided numerical range or amount includes the amounts of the specific form and/or compounds that are equivalent to the specific form. For example, vitamin D may be in the form vitamin D₃ and may be included in the amount of about 1000 IU. Accordingly, in this example, “vitamin D₃ in the amount of about 1000 IU” would include 1000 IU of vitamin D₃ and/or its equivalents and would, for example, include a product having 1000 IU vitamin D₂ instead of vitamin D₃, as well as intended overages of vitamin D, in any form.

In another embodiment, vitamin D may be present in an amount determined by a measure of mass, as opposed to International Units. One International Unit (IU) of vitamin D is defined as the biological equivalent of about 0.025 μg of vitamin D₃.

In some embodiments of the compositions, kits, and methods disclosed herein, iron may be included. In certain embodiments, iron may be included in one or more of the forms of elemental iron, in the form of a salt, chelated form, non-chelated form, chelated to an amino acid, carbonyl iron, ferrous gluconate, ferrous fumarate, polysaccharide iron complex, elemental polysaccharide iron, polysaccharide iron, ferrous (II)-bis-glycinate chelate, ferrous asparto glycinate, ferrous bisglycinate, ferrous bisglycinate hydrochloride, ferrous bisglycinate, elemental ferrous bisglycinate, ferrous sulfate, ferronyl (micronized), as Iron Aid, iron protein succinylate, carbonyl iron, Sumalate iron, Heme iron complex, as Ferrochel amino acid chelate, heme iron polypeptide as Proferrin-bovine source, as heme iron polypeptide (bovine source), as sodium iron EDTA (Ferrazone), ferric ammonium citrate, elemental iron, ferric orthophosphate (also known as ferric phosphate or iron (III) phosphate), and ferric pyrophosphate. In a specific embodiment, iron may be included in the form of iron hydroxide polysaccharide complex. In another specific embodiment, iron may be included in the form of ferrous fumurate.

In some embodiments of the compositions, kits, and methods disclosed herein, iron may be included in an amount ranging from about 9 mg to about 27 mg. In some embodiments, iron may be included in an amount ranging from about 12 mg to about 24 mg. In some embodiments, iron may be included in an amount ranging from about 15 mg to about 21 mg. In certain specific embodiments, iron may be included in an amount of about 9 mg, about 10 mg, about 11 mg, about 12 mg, about 13 mg, about 14 mg, about 15 mg, about 16 mg, about 17 mg, about 18 mg, about 19 mg, about 20 mg, about 21 mg, about 22 mg, about 23 mg, about 24 mg, about 25 mg, about 26 mg, or about 27 mg. In certain specific embodiments, iron may be included in an amount of at least about 9 mg, at least about 10 mg, at least about 11 mg, at least about 12 mg, at least about 13 mg, at least about 14 mg, at least about 15 mg, at least about 16 mg, at least about 17 mg, at least about 18 mg, at least about 19 mg, at least about 20 mg, at least about 21 mg, at least about 22 mg, at least about 23 mg, at least about 24 mg, at least about 25 mg, at least about 26 mg, or at least about 27 mg. In some embodiments of the compositions, kits, and methods disclosed herein, iron may be included in an overage amount of up to about 105% of the specified label amount.

In some embodiments, iron may be included in specific ranges or amounts for each specific form. When provided in their specific forms, the provided numerical range or amount includes the amounts of the specific form and/or compounds that are equivalent to the specific form. For example, iron may be in the form iron hydroxide polysaccharide complex and may be included in the amount to provide about 18 mg of elemental iron. Accordingly, in this example, “iron hydroxide polysaccharide complex in the amount to provide about 18 mg of elemental iron” would include the amount of iron hydroxide polysaccharide complex in the amount to provide about 18 mg of elemental iron and/or its equivalents and would, for example, include a product having ferrous fumarate instead of iron hydroxide polysaccharide complex, as well as intended overages of iron, in any form.

In some embodiments of the compositions, kits, and methods disclosed herein, iodine may be included. In certain embodiments, iodine may be included in one or more of the forms of elemental iodine, iodized salt, Lugol's iodine, sodium iodide, potassium iodide, potassium iodate, nascent iodine, and Nano-Colloidal Detoxified Iodine. In some embodiments, iodine may be potassium iodide.

In some embodiments of the compositions, kits, and methods disclosed herein, iodine may be included in an amount ranging from about 75 μg to about 225 μg. In some embodiments, iodide may be included in an amount ranging from about 120 μg to about 180 μg. In some embodiments, iodide may be included in an amount ranging from about 135 μg to about 165 μg. In certain specific embodiments, iodine may be included in an amount of about 75 μg, about 80 μg, about 90 μg, about 100 μg, about 110 μg, about 120 μg, about 130 μg, about 140 μg, about 150 μg, about 160 μg, about 170 μg, about 180 μg, about 190 μg, about 200 μg, about 210 μg, about 220 μg, or about 225 μg. In certain specific embodiments, iodine may be included in an amount of at least about 75 μg, at least about 80 μg, at least about 90 μg, at least about 100 μg, at least about 110 μg, at least about 120 μg, at least about 130 μg, at least about 140 μg, at least about 150 μg, at least about 160 μg, at least about 170 μg, at least about 180 μg, at least about 190 μg, at least about 200 μg, at least about 210 μg, at least about 220 μg, or at least about 225 μg. In some embodiments of the compositions, kits, and methods disclosed herein, iodine may be included in an overage amount of up to about 125% of the specified label amount.

In some embodiments, iodine may be included in specific ranges or amounts for each specific form. When provided in their specific forms, the provided numerical range or amount includes the amounts of the specific form and/or compounds that are equivalent to the specific form. For example, iodine may be in the form potassium iodide and may be included in the amount to provide about 150 μg of iodine. Accordingly, in this example, “potassium iodide in the amount to provide about 150 μg of iodine” would include potassium iodide in the amount to provide about 150 μg of iodine and/or its equivalents and would, for example, include a product having Nano-Colloidal Detoxified instead of potassium iodide, as well as intended overages of iodide, in any form.

In some embodiments, the compositions, kits, and methods disclosed herein may be used as a dietary supplement. In some embodiments, the composition, kits and methods disclosed herein may be used as a prenatal vitamin. In some embodiments, the compositions, kits and methods disclosed herein, may be administered to a patient, such as a pregnant woman, prenatal woman, or a woman who is breast-feeding. In some embodiments, the compositions, kits and methods disclosed herein, may be administered to a patient before, during, and after the patient's pregnancy. In some embodiments, the methods disclosed herein may comprise administering compositions and kits disclosed herein once a day, twice a day, three times a day, four times a day, or five times a day. In some embodiments, the methods disclosed herein may comprise administering compositions and kits disclosed herein once daily. In some embodiments, the methods disclosed herein may comprise administering compositions and kits disclosed herein as directed by a physician. In some embodiments, the compositions and kits may be utilized or administered in a single dosage form, or in multiple dosage forms, once a day, twice a day, three times a day, four times a day, or five times a day. In some embodiments, the compositions and kits may be utilized or administered once daily. In some embodiments, the compositions and kits may be utilized or administered as directed by a physician. In some embodiments, multiple compositions or kits disclosed herein may be administered at the same time or administered separately. In some embodiments, when multiple compositions are provided in a kit, the compositions may be administered at the same time or administered separately. In a specific embodiment, the compositions and kits of the present invention are administered once daily in a single tablet dosage form.

The compositions for nutritional supplementation disclosed herein may comprise any necessary inactive ingredients for formulating the active ingredients. In some embodiments, the compositions may comprise one or more inactive ingredients. These inactive ingredients may include, but are not limited to: water; anticaking agents (including, by way of example and without limitation, silica (e.g., Sipernat® 50 S, manufactured by Evonik Industries®, Parsippany, N.J.), aluminosilicate salts, and others known to those of ordinary skill in the art); binders (including, by way of example and without limitation, hydroxypropyl cellulose, microcrystalline cellulose, starch (e.g., modified food starch), sugars (e.g., sucrose, glucose, etc.), natural and synthetic gums, polyethylene glycol, alcohol, and others known to those of ordinary skill in the art); disintegrants (including, by way of example and without limitation, hydroxypropyl cellulose, croscarmellose sodium, corn starch, potato starch, crospovidone, methylcellulose, agar, and others known to those of ordinary skill in the art); lubricants (including, by way of example, and without limitation, talc, magnesium stearate, calcium stearate, polyethylene glycol (PEG), and others known to those of ordinary skill in the art); buffers (including, by way of example and without limitation, phosphate buffers (e.g., dibasic calcium phosphate), citrate buffers, lactic acid, and others known to those of ordinary skill in the art); stabilizing agents (including, by way of example and without limitation, antioxidants (e.g., ascorbic acid (or sodium ascorbate), propionic acid, sodium bisulfite, sodium sulfite, dl-alpha-tocopherol, and the like)); chelating agents (e.g., fumaric acid, sodium edetate, and the like), and others known to those of ordinary skill in the art); surfactants (including, by way of example and without limitation, wetting agents (e.g., sorbitan monolaurate, etc.), antifoaming agents (e.g., sorbitan trioleate, etc.), detergents (e.g., sucrose stearate, etc.), solubilizing agents (e.g., polyethylene glycol 400 monostearate, etc.), and others known to those of ordinary skill in the art); processing aids (e.g., substances used to assist processing, including, by way of example and without limitation, lubricating agents, antioxidants, and others known to those of ordinary skill in the art); lubricating agents (including, by way of example and without limitation, stearic acid, calcium stearate, magnesium stearate, zinc stearate, talc, mineral and vegetable oils, benzoic acid, poly(ethylene glycol), glyceryl behenate, stearyl fumarate, and others known to those of ordinary skill in the art); emulsifiers (including, by way of example and without limitation, synthetic (e.g., sodium lauryl sulfate, potassium laurate, polyvinyl alcohol, etc.), natural (e.g., gelatin, lecithin, etc.), and finely divided solid emulsifiers (e.g., bentonite, magnesium hydroxide, etc.), and others known to those of ordinary skill in the art); suspending agents (including, by way of example and without limitation, cellulose derivatives (e.g., carboxymethylcellulose (i.e., sodium carboxymethylcellulose)), methylcellulose, ethyl cellulose, etc.), natural polymers (e.g., alginates, xanthan gum, guar gum, etc.), synthetic polymers (e.g., carbomers, polyvinyl pyrrolidone, polyvinyl alcohol, etc.), clays (e.g., magnesium aluminum silicate, hectorite, etc.), and others known to those of ordinary skill in the art); preservatives (including, by way of example and without limitation, benzalkonium chloride, benzethonium chloride, benzyl alcohol, cetrimide, glycerin, propylene glycol, benzoic acid and sodium benzoate, potassium sorbate and sorbic acid, and others known to those of ordinary skill in the art); opaquing agents (including, by way of example and without limitation, titanium dioxide, and others known to those of ordinary skill in the art); glidants (including, by way of example and without limitation, silicon dioxide, colloidal or fumed silica, magnesium stearate, calcium stearate, stearic acid, cornstarch, talc and others known to those of ordinary skill in the art); diluents (including, by way of example and without limitation, corn syrup, lactose, sodium chloride, sucrose (sugar), and others known to those of ordinary skill in the art); colorants (including, by way of example and without limitation, FD&C Red No. 3, FD&C Red No. 20, FD&C Yellow No. 6, FD&C Blue No. 2 (i.e., FD&Blue No. 2 Aluminum Lake, i.e. indigo carmine), D&C Green No. 5, FD&C Orange No. 5, D&C Red No. 8, caramel, ferric oxide, red, pigments, dyes, tints, titanium dioxide, natural coloring agents, such as grape skin extract, beet red powder, beta carotene, annato, carmine, turneric, paprika, black carrot juice, and others known to those of ordinary skill in the art); sweeteners or sweetening agents (including, by way of example and without limitation, sucrose, fructose, fructose, high fructose corn syrup, dextrose, saccharin sodium, maltodextrin, aspartame, potassium acesulfame, neohesperidin dihydrochalcone, sucralose, monoammonium glycyrrhizinate, and others known to those of ordinary skill in the art); perfuming agents (including, by way of example and without limitation, natural flavor oil, a synthetic flavor oil, and others known to those of ordinary skill in the art), glazing agents (including, by way of example and without limitation, vegetable oil, beeswax, carnauba wax, and others known to those of ordinary skill in the art); flavoring agents or flavorant (including, by way of example and without limitation, natural flavor oil, synthetic flavor oil, and other masking flavors known to those of ordinary skill in the art); and other excipients (i.e., medium chain tiglycerides, etc.) known to those of ordinary skill in the art. Additional examples of other inactive ingredients are well known in the art. See, e.g., Remington: The Science and Practice of Pharmacy (21st ed. 2005). Such flavorants and sweeteners may assist in increasing patient compliance.

In some embodiments of the compositions, kits, and methods disclosed herein, at least one inactive ingredient may be included. In some embodiments, the at least one inactive ingredient may be a sweetener or sweetening agent. In some embodiments, the sweetener or sweetening agent may be one or more selected from the group consisting of sucrose, fructose, fructose, high fructose corn syrup, dextrose, saccharin sodium, maltodextrin, aspartame, potassium acesulfame, neohesperidin dihydrochalcone, sucralose, monoammonium glycyrrhizinate, and mixtures thereof. In some embodiments, the sweetener or sweetening agent may be sucralose.

The ingredients of the invention disclosed herein are preferably combined into a composition which may be in the form of a solid powder, caplets, tablets, lozenges, pills, capsules, or a liquid, and which may be administered alone or in suitable combination with other components. For example, the compositions disclosed herein may be administered in one or more caplets, tablets, or lozenges as practical for ease of administration. Each of the vitamins and minerals is preferably commercially available, and can be blended to form a single composition or can form multiple compositions, which may be co-administered.

To prepare the compositions described herein, each of the active ingredients may be combined in intimate admixture with a suitable carrier according to conventional compounding techniques. The carrier may take a wide variety of forms depending upon the form of the preparation desired for administration, e.g., oral, sublingual, nasal, topical patch, or parenteral.

In some embodiments of the compositions, kits, and methods disclosed herein, the composition may be in an oral dosage form. In some embodiments, a composition may consist of one to three tablets, caplets or lozenges, the composition of each being identical to each other caplet or lozenge.

In preparing a composition in oral dosage form, any of the usual media may be utilized. For liquid preparations (e.g., suspensions, elixirs, and solutions), media containing, for example, water, oils, alcohols, flavoring agents, preservatives, coloring agents and the like may be used. Carriers such as starches, sugars, diluents, granulating agents, lubricants, binders, disintegrating agents and the like may be used to prepare oral solids (e.g., powders, caplets, pills, tablets, capsules, and lozenges). Controlled release forms may also be used. Because of their ease in administration, caplets, tablets, pills, and capsules may be an advantageous oral dosage unit form, in which case solid carriers are employed. In some embodiments, the compositions may be any known type of tablet, including but not limited to, compressed tablets (such as sugar-coated tablets, film-coated tablets, enteric-coated tablets, multiple compressed tablets, controlled-release tablets, tablets for solution, effervescent tablets, buccal and sublingual tablets, and the like) and molded tablets or tablet triturates. In some embodiments, the composition may be a coated tablet. In some embodiments, Opadry II® (manufactured by Colorcon®, Harleysville, Pa.) may be used as a film coating system for forming an oral solid dosage form of a composition described herein. All of these pharmaceutical carriers and formulations, as well as techniques of making such formulations, are well known to those of ordinary skill in the art. See, e.g., Wade & Waller, Handbook of Pharmaceutical Excipients (2nd ed. 1994); Remington: The Science and Practice of Pharmacy (21st ed. 2005).

In some embodiments, the nutritional supplements described herein may include multiple vitamins, nutrients and minerals in a composition. Providing a single composition multivitamin and multinutrient supplement may be an appealing feature because it may improve patient compliance. Patients, and specifically for example, pregnant patients, often have nausea, and may have difficulties taking multiple pills. A single composition for nutritional supplement that includes the beneficial vitamins, nutrients and minerals in appropriate dosage amounts may thus be beneficial for improving patient compliance in, for example, pregnant women. In some embodiments, the reduced weight and/or volume of the compositions disclosed herein, as compared to the weight and/or volume of other compositions for nutritional supplementation, including prenatal vitamin compositions, may improve patient compliance as compared to these compositions. In some embodiments, the reduced weight and/or volume of the compositions disclosed herein, as compared to the weight and/or volume of other compositions for nutritional supplementation, including prenatal vitamin compositions, may help a patient be able to swallow the composition. In some embodiments, the composition may be swallowed by a patient without the need for chewing the composition.

In some embodiments, the composition may have a weight of about 70 mg to about 210 mg. In some embodiments, the composition may have a weight of about 100 mg to about 180 mg. In some embodiments, the composition may have a weight of about 70 mg, about 75 mg, about 80 mg, about 85 mg, about 90 mg, about 95 mg, about 100 mg, about 105 mg, about 110 mg, about 115 mg, about 120 mg, about 125 mg, about 130 mg, about 135 mg, about 140 mg, about 145 mg, about 150 mg, about 155 mg, about 160 mg, about 165 mg, about 170 mg, about 175 mg, about 180 mg, about 185 mg, about 190 mg, about 195 mg, about 200 mg, about 205 mg, or about 210 mg. In some embodiments, the composition may have a weight of at least about 70 mg, at least about 75 mg, at least about 80 mg, at least about 85 mg, at least about 90 mg, at least about 95 mg, at least about 100 mg, at least about 105 mg, at least about 110 mg, at least about 115 mg, at least about 120 mg, at least about 125 mg, at least about 130 mg, at least about 135 mg, at least about 140 mg, at least about 145 mg, at least about 150 mg, at least about 155 mg, at least about 160 mg, at least about 165 mg, at least about 170 mg, at least about 175 mg, at least about 180 mg, at least about 185 mg, at least about 190 mg, at least about 195 mg, at least about 200 mg, at least about 205 mg, or at least about 210 mg. In some embodiments, the composition may have a weight of less than about 210 mg, less than about 205 mg, less than about 200 mg, less than about 195 mg, less than about 190 mg, less than about 185 mg, less than about 180 mg, less than about 175 mg, less than about 170 mg, less than about 165 mg, less than about 160 mg, less than about 155 mg, less than about 150 mg, less than about 145 mg, less than about 140 mg, less than about 135 mg, less than about 130 mg, less than about 125 mg, less than about 115 mg, less than about 105 mg, less than about 110 mg, less than about 105 mg, or less than about 100 mg.

In some embodiments, the volume of the composition may be about 1.5 cm³ to about 0.01 cm³, about 1 cm³ to about 0.1 cm³, about 0.2 cm³ to about 0.7 cm³, about 0.175 cm³ to about 0.01 cm³, about 0.150 cm³ to about 0.050 cm³, or about 0.125 cm³ to about 0.05 cm³. In some embodiments, the volume of the composition may be about 1.5 cm³, about 1.4 cm³, about 1.3 cm³, about 1.2 cm³, about 1.1 cm³, about 1.0 cm³, about 0.9 cm³, about 0.8 cm³, about 0.7 cm³, about 0.6 cm³, about 0.5 cm³, about 0.45 cm³, about 0.4 cm³, about 0.35 cm³, about 0.3 cm³, about 0.25 cm³, about 0.2 cm³, about 0.15 cm³, about 0.145 cm³, about 0.14 cm³, about 0.135 cm³, about 0.13 cm³, about 0.125 cm³, about 0.12 cm³, about 0.115 cm³, about 0.11 cm³, about 0.109 cm³, about 0.108 cm³, about 0.107 cm³, about 0.106 cm³, about 0.105 cm³, about 0.104 cm³, about 0.103 cm³, about 0.102 cm³, about 0.101 cm³, about 0.1 cm³, about 0.095 cm³, about 0.09 cm³, about 0.085 cm³, about 0.08 cm³, about 0.075 cm³, about 0.07 cm³, about 0.065 cm³, about 0.06 cm³, about 0.055 cm³, or about 0.05 cm³. In some embodiments, the volume of the composition may be at least about 1.5 cm³, at least about 1.4 cm³, at least about 1.3 cm³, at least about 1.2 cm³, at least about 1.1 cm³, at least about 1.0 cm³, at least about 0.9 cm³, at least about 0.8 cm³, at least about 0.7 cm³, at least about 0.6 cm³, at least about 0.5 cm³, at least about 0.45 cm³, at least about 0.4 cm³, at least about 0.35 cm³, at least about 0.3 cm³, at least about 0.25 cm³, at least about 0.2 cm³, at least about 0.15 cm³, at least about 0.145 cm³, at least about 0.14 cm³, at least about 0.135 cm³, at least about 0.13 cm³, at least about 0.125 cm³, at least about 0.12 cm³, at least about 0.115 cm³, at least about 0.11 cm³, at least about 0.109 cm³, at least about 0.108 cm³, at least about 0.107 cm³, at least about 0.106 cm³, at least about 0.105 cm³, at least about 0.104 cm³, at least about 0.103 cm³, at least about 0.102 cm³, at least about 0.101 cm³, at least about 0.1 cm³, at least about 0.095 cm³, at least about 0.09 cm³, at least about 0.085 cm³, at least about 0.08 cm³, at least about 0.075 cm³, at least about 0.07 cm³, at least about 0.065 cm³, at least about 0.06 cm³, at least about 0.055 cm³, or at least about 0.05 cm³. In some embodiments, the volume of the composition may be less than about 1.5 cm³, less than about 1.4 cm³, less than about 1.3 cm³, less than about 1.2 cm³, less than about 1.1 cm³, less than about 1 cm³, less than about 0.9 cm³, less than about 0.8 cm³, less than about 0.7 cm³, less than about 0.6 cm³, less than about 0.5 cm³, less than about 0.45 cm³, less than about 0.4 cm³, less than about 0.35 cm³, less than about 0.3 cm³, less than about 0.25 cm³, less than about 0.2 cm³, less than about 0.15 cm³, less than about 0.145 cm³, less than about 0.14 cm³, less than about 0.135 cm³, less than about 0.13 cm³, less than about 0.125 cm³, less than about 0.12 cm³, less than about 0.115 cm³, less than about 0.11 cm³, less than about 0.109 cm³, less than about 0.108 cm³, less than about 0.107 cm³, less than about 0.106 cm³, less than about 0.105 cm³, less than about 0.104 cm³, less than about 0.103 cm³, less than about 0.102 cm³, less than about 0.101 cm³, less than about 0.1 cm³, less than about 0.095 cm³, less than about 0.09 cm³, less than about 0.085 cm³, less than about 0.08 cm³, less than about 0.075 cm³, less than about 0.07 cm³, less than about 0.065 cm³, less than about 0.06 cm³, less than about 0.055 cm³, or less than about 0.05 cm³.

In another embodiment, the nutritional supplements described herein may include multiple vitamins, nutrients and minerals in more than one composition. In a specific embodiment, various active ingredients may be incorporated into multiple compositions as a kit. In another example, the multiple compositions may be separated due to size or large dosage amounts of specific ingredients. In another example, the nutritional supplementation of a multivitamin may not be adequate in one composition. Accordingly, all the active ingredients may be divided into a total of two compositions, three compositions, four compositions and five compositions. In one embodiment, each composition may have equal amounts of each active ingredient. In another embodiment, compositions may have unequal amounts of various active ingredients, or merely supplemental amounts of specific active ingredients.

In some embodiments, the compositions disclosed herein may be packaged as kits using materials known to those of ordinary skill in the art. In some embodiments, kits comprising the disclosed compositions may be packaged in blister packs. Blister packs as packaging for compositions are well known to those of ordinary skill in the art. Blister packs may be made of a transparent plastic sheet which has been formed to carry a matrix of depression or blisters. One or more compositions are received in each depression or blister. A foil or plastic backing is then adhered across the plane of the sheet sealing the compositions in their respective blisters. Examples of materials used for the blister packs include, but are not limited to, aluminum, paper, polyester, PVC, and polypropylene. Alternative materials are known to those of ordinary skill in the art. To remove a composition, the depression material is pressed in and the composition is pushed through the backing material. Multiple blister packs may be placed in an outer package, often a box or carton for sale and distribution.

Another specific embodiment provides for one or more of the disclosed compositions that may be packaged in bottles. The bottle may be glass or plastic in form with a pop or screw top cap. Bottle packaging for compositions as disclosed herein are well known to those of ordinary skill in the art. Additionally, the disclosed compositions may be individually wrapped, packaged as multiple units on paper strips or in vials of any size, without limitation. The compositions of the invention may be packaged in unit dose, rolls, bulk bottles, blister packs and combinations thereof, without limitation.

Omega-3 fatty acids, such as docosahexaenoic acid (or docahexaenoic acid, DHA), also play integral roles in physiological mechanisms that serve to prevent, treat and/or alleviate the occurrence or negative effects of some diseases. Thus, in some embodiments, at least one omega-3 fatty acid may be co-administered with the compositions and kits disclosed herein. In some embodiments, the methods disclosed herein further may comprise the co-administration of at least one omega-3 fatty acid with the compositions and kits disclosed herein. In some embodiments, a composition that may comprise at least one omega-3 fatty acid may be co-administered with the compositions and kits disclosed herein. In some embodiments, the methods disclosed herein further may comprise the co-administration of a composition that may comprise at least one omega-3 fatty acid with the compositions and kits disclosed herein. Some embodiments also provide for a kit wherein at least one omega-3 acid may be packaged along with at least one composition as described herein for co-administration to a patient. Some embodiments also provide for a kit, wherein the kit may include a first composition that may comprise at least one omega-3 acid and may be packaged along with one or more of the compositions for nutritional supplementation as described herein for co-administration to a patient.

In certain embodiments, the at least one omega-3 fatty acid may comprise one or more of docahexaenoic acid (or docosahexaenoic acid, DHA), eicosapentaenoic acid (EPA), and α-linolenic acid (ALA). DHA may be obtained in solid form, such as in a whole-cell microbial product, or in liquid form, such as an oil. A non-limiting example of DHA in oil form is DHASCO®-T vegetable oil from micro-algae (Martek Biosciences Corporation, Columbia, Md.). In a specific embodiment, the DHA may be DHAgold® (Martek Biosciences, Columbia, Md.), life's DHA™ (DSM Nutritional Products, Parsippany, N.J.) (DHASCO®, Martek Biosciences Corporation, Columbia, Md.), any Algae Oil, Krill Oil and/or vegetarian DHA.

In specific embodiments, the source of DHA may be from one or more of animal, fish, plants, algae or microorganism production. In some embodiments, DHA may be derived from algae. In a specific embodiment, the source of DHA may be from algae oil. In other specific embodiments, the source of algae oil may be one or more of microalgae Schizochytrium sp., microalgae Crypthecodinium cohnii, microalgae Ulkenia sp. SAM2179, microalgae Schizochytrium linacinum strain SC-1. In another specific embodiment the source of DHA may be Martek Oil C53-O100 (Martek Biosciences Corporation, Columbia, Md.). In another embodiment, the at least one omega-3 fatty acid may be enclosed in a gel-cap, as, for example, in a kit with the compositions of the present invention, or may be in liquid form.

In another specific embodiment, the at least one omega-3 fatty acid may be present in the amount of about 25 mg to about 250 mg, about 50 mg to about 200 mg, about 50 mg to about 150 mg, about 75 mg to about 125 mg, or about 90 mg to about 110 mg. In some embodiments, the at least one omega-3 fatty acid may be present in the amount of about 25 mg, about 30 mg, about 35 mg, about 40 mg, about 45 mg, about 50 mg, about 55 mg, about 60 mg, about 65 mg, about 70 mg, about 75 mg, about 80 mg, about 85 mg, about 90 mg, about 95 mg, about 100 mg, about 105 mg, about 110 mg, about 115 mg, about 120 mg, about 125 mg, about 130 mg, about 135 mg, about 140 mg, about 145 mg, about 150 mg, about 155 mg, about 160 mg, about 165 mg, about 170 mg, about 175 mg, about 180 mg, about 185 mg, about 190 mg, about 195 mg, about 200 mg, about 205 mg, about 210 mg, about 215 mg, about 220 mg, about 225 mg, about 230 mg, about 235 mg, about 240 mg, about 245 mg, or about 250 mg. In some embodiments, the at least one omega-3 fatty acid may be present in the amount of at least about 25 mg, at least about 30 mg, at least about 35 mg, at least about 40 mg, at least about 45 mg, at least about 50 mg, at least about 55 mg, at least about 60 mg, at least about 65 mg, at least about 70 mg, at least about 75 mg, at least about 80 mg, at least about 85 mg, at least about 90 mg, at least about 95 mg, at least about 100 mg, at least about 105 mg, at least about 110 mg, at least about 115 mg, at least about 120 mg, at least about 125 mg, at least about 130 mg, at least about 135 mg, at least about 140 mg, at least about 145 mg, at least about 150 mg, at least about 155 mg, at least about 160 mg, at least about 165 mg, at least about 170 mg, at least about 175 mg, at least about 180 mg, at least about 185 mg, at least about 190 mg, at least about 195 mg, at least about 200 mg, at least about 205 mg, at least about 210 mg, about 215 mg, at least about 220 mg, at least about 225 mg, at least about 230 mg, at least about 235 mg, at least about 240 mg, at least about 245 mg, or at least about 250 mg.

In some embodiments, omega-3 fatty acids may be included in specific ranges or amounts for each specific form. When provided in their specific forms, the provided numerical range or amount includes the amounts of the specific form and/or compounds that are equivalent to the specific form. For example, omega-3 fatty acids may be in the form of DHA and may be included in the amount of about 75 mg. Accordingly, in this example, “DHA in the amount of about 75 mg” would include 75 mg of DHA and/or its equivalents and would, for example, include a product having 75 mg EPA instead of DHA, as well as intended overages of the omega-3 fatty acid, in any form.

In some embodiments, any vitamins, nutrients and/or minerals may be explicitly excluded from the compositions disclosed herein. By way of non-limiting example, in some embodiments, the compositions disclosed herein may be substantially free of added alpha carotene; substantially free of added lutein; substantially free of added lycopene; substantially free of added zeaxanthin; substantially free of added vitamin B₄; substantially free of added vitamin B₅; substantially free of added vitamin B₇; substantially free of added vitamin B₈; substantially free of added vitamin B₁₀; substantially free of added vitamin B₁₁; substantially free of added calcium; substantially free of added chromium; substantially free of added copper; substantially free of added manganese; substantially free of added selenium; substantially free of added boron; substantially free of added odorless garlic; substantially free of added coenzyme Q-10; substantially free of added 1-carnitine; substantially free of added grape seed extract; substantially free of added green tea extract; substantially free of added quercetin; substantially free of added hawthorne berries; and/or substantially free of added alpha lipoic acid. In some embodiments, the compositions may be substantially free of other added vitamins and minerals.

The term “substantially free of added” as used herein means free from therapeutically effective amounts of compounds when administered in suggested doses, but may include trace amounts of compounds in non-therapeutically effective amounts. For example, a composition of the present disclosure that includes an inactive ingredient that is a salt or compound including a mineral would still be substantially free of added minerals. For example, trace amounts of titanium dioxide may be provided. Titanium dioxide which is an effective opacifier in powder form, where it is employed as a pigment to provide whiteness and opacity to numerous pharmaceutical products.

Other objectives, features and advantages of the disclosed invention will become apparent from the following specific examples. The specific examples, while indicating specific embodiments of the invention, are provided by way of illustration only. Accordingly, the inventions disclosed herein also include those various changes and modifications within the spirit and scope of the invention that may become apparent to those skilled in the art from this detailed description. The invention will be further illustrated by the following non-limiting examples.

### EXAMPLES

### Example 1

A representative composition. Such composition was prepared according to standard methods known to those of ordinary skill in the art.

| INGREDIENT | AMOUNT | |
|---|---|---|
| Vitamin B₉ (as a combination of folic acid | 1 | mg |
| and the calcium salt of L-methylfolate) | | |
| Vitamin B₁₂ (as cobalamin) | 12 | μg |
| Iodine (as potassium iodide) | 150 | μg |
| Vitamin B₆ (as pyridoxine hydrochloride) | 2.5 | mg |
| Vitamin D (as cholecalciferol) | 1000 | IU |
| Iron (as ferrous fumarate) | 18 | mg |

Inactive Ingredients: Sipernat ® 50 S, croscarmellose sodium, microcrystalline cellulose, hydroxypropyl cellulose, magnesium stearate, Opadry II ®, water, sucralose.

### Example 2

A representative composition. Such composition was prepared according to standard methods known to those of ordinary skill in the art.

| INGREDIENT | AMOUNT | |
|---|---|---|
| Vitamin B₉ (as a combination of folic acid | 1 | mg |
| and the calcium salt of L-methylfolate) | | |
| Vitamin B₁₂ (as cyanocobalamin) | 12 | μg |
| Iodine (as potassium iodide) | 150 | μg |
| Vitamin B₆ (as pyridoxine hydrochloride) | 2.5 | mg |
| Vitamin D (as cholecalciferol) | 1000 | IU |
| Iron (as ferrous fumarate) | 18 | mg |

Inactive Ingredients: microcrystalline cellulose, hydroxypropyl cellulose, modified food
starch, croscarmellose sodium, magnesium stearate, sucrose, silicon dioxide, dibasic
calcium phosphate, sodium ascorbate, medium chain triglycerides, dl-alpha-tocopherol,
polyvinyl alcohol, titanium dioxide, polyethylene glycol, talc, sucralose, FD&C Blue #2/
Indigo Carmine Aluminum Lake.

### Example 3

### Clinical Trial of Representative Compositions Disclosed Herein

A study is undertaken to evaluate the effectiveness of the compositions of the present disclosure in the treatment of patients. The objective of the study is to determine whether oral intake of the compositions results in an improvement of the nutritional status of patients with regard to the specific vitamins and minerals contained in the administered compositions, particularly through improved patient compliance.

A double-blind, placebo controlled study is conducted over a six-month period. A total of 120 subjects (60 pregnant women entering the second trimester of pregnancy and 60 lactating women), aged 20-35 years, are chosen for the study. An initial assessment of the nutritional status of each woman is conducted. Vitamin B₆ is measured using high performance liquid chromatography. Vitamin B₉ is measured by radioimmunoassay (RIA), specifically The Solid Phase No Biol Folic Acid Kit (Diagnostic Products, Los Angeles, Calif.). Vitamin B₁₂ is measured by RIA using human intrinsic factor as a binder. Vitamin D is measured using an extraction double-antibody RIA (Dia Sorin, Inc., Stillwater, Minn.). Iron levels are measured using standard spectrophotometry. Iodine levels are measured by HPLC.

Additionally, total serum homocysteine levels are determined by extraction on the Multi-Prep® gravity series GVSA-100 column, a strong anion exchange gravity flow column, and measurement by gas chromatography/mass spectrometry. Biochemical Diagnostics, Austin, Tex.

The 120 subjects are separated into four separate groups of 30 women. In a first group comprising only pregnant women and in a second group comprising only lactating women, each subject is administered one dosage form of the composition as described in Example 2 and having a weight of about 145 mg once a day. In a third group comprising only pregnant women and in a fourth group comprising only lactating women, each subject is administered one placebo dosage form once a day, the placebo dosage form having a weight of about 800 mg, a typical weight as other commercially available prenatal vitamins (i.e., having a greater weight as compared to the compositions disclosed herein). Thus, dosage form administration occurs every 24 hours. No other nutritional supplements are taken by the subjects during the assessment period.

An assessment of the nutritional status of each woman is conducted utilizing the methods described above at one month intervals for a six month period. The data is evaluated using multiple linear regression analysis and a standard t-test. In each analysis, the baseline value of the outcome variable is included in the model as a covariant. Treatment by covariant interaction effects is tested by the method outlined by Weigel & Narvaez, 12 CONTROLLED CLINICAL TRIALS 378-94 (1991). If there are no significant interaction effects, the interaction terms are removed from the model. The regression model assumptions of normality and homogeneity of variance of residuals are evaluated by inspection of the plots of residuals versus predicted values. Detection of the temporal onset of effects is done sequentially by testing for the presence of significant treatment effects at 1, 2, 3, 4, 5, and 6 months, proceeding to the earlier time in sequence only when significant effects have been identified at each later time period. Changes from the baseline within each group are evaluated using paired t-tests. In addition, analysis of variance is performed on all baseline measurements and measurable subject characteristics to assess homogeneity between groups. All statistical procedures are conducted using the Statistical Analysis System (SAS Institute Inc., Cary, N.C.). An alpha level of 0.05 is used in all statistical tests.

An unexpected statistically significant improvement in the nutritional status of vitamin, mineral, and nutrient levels measured is observed in the treated subjects over the controls upon completion of the study. Specifically, homocysteine levels in women receiving supplements remain unelevated. Moreover, patients in the test group show statistically significant increased patient compliance with the compositions described herein over the placebo dosage form having the greater weight of other commercially available prenatal vitamins and do not report significant adverse events. Therefore, the study confirms that oral administration of the compositions of the present disclosure is effective in improving the nutritional status of patients and increasing patient compliance. Other unexpected results relate to the observation that the homocysteine levels in women receiving the supplements are not elevated, due to folic acid intake, leading to a better prognosis regarding risk of neural tube defects in their infants.

### Example 4

### Clinical Trial of Representative Compositions Disclosed Herein

A study is undertaken to evaluate the effectiveness of the compositions of the present disclosure in the treatment of patients. The objective of the study is to determine whether oral intake of the compositions results in an improvement of the nutritional status of patients with regard to the specific vitamins and minerals contained in the administered compositions, particularly through improved patient compliance.

A double-blind, placebo controlled study is conducted over a six-month period. A total of 120 subjects (60 pregnant women entering the second trimester of pregnancy and 60 lactating women), aged 20-35 years, are chosen for the study. An initial assessment of the nutritional status of each woman is conducted. Vitamin B₆ is measured using high performance liquid chromatography. Vitamin B₉ is measured by radioimmunoassay (RIA), specifically The Solid Phase No Biol Folic Acid Kit (Diagnostic Products, Los Angeles, Calif.). Vitamin B₁₂ is measured by RIA using human intrinsic factor as a binder. Vitamin D is measured using an extraction double-antibody RIA (Dia Sorin, Inc., Stillwater, Minn.). Iron levels are measured using standard spectrophotometry. Iodine levels are measured by HPLC.

Additionally, total serum homocysteine levels are determined by extraction on the Multi-Prep® gravity series GVSA-100 column, a strong anion exchange gravity flow column, and measurement by gas chromatography/mass spectrometry. Biochemical Diagnostics, Austin, Tex.

The 120 subjects are separated into four separate groups of 30 women. In a first group comprising only pregnant women and in a second group comprising only lactating women, each subject is administered one dosage form of the composition as described in Example 2 and having a volume of about 0.105 cm³ once a day. In a third group comprising only pregnant women and in a fourth group comprising only lactating women, each subject is administered one placebo dosage form once a day, the placebo dosage form having a volume of 0.68 cm³, a typical volume as other commercially available prenatal vitamins (i.e., having a greater volume as compared to the compositions disclosed herein). Thus, dosage form administration occurs every 24 hours. No other nutritional supplements are taken by the subjects during the assessment period.

An assessment of the nutritional status of each woman is conducted utilizing the methods described above at one month intervals for a six month period. The data is evaluated using multiple linear regression analysis and a standard t-test. In each analysis, the baseline value of the outcome variable is included in the model as a covariant. Treatment by covariant interaction effects is tested by the method outlined by Weigel Narvaez, 12 CONTROLLED CLINICAL TRIALS 378-94 (1991). If there are no significant interaction effects, the interaction terms are removed from the model. The regression model assumptions of normality and homogeneity of variance of residuals are evaluated by inspection of the plots of residuals versus predicted values. Detection of the temporal onset of effects is done sequentially by testing for the presence of significant treatment effects at 1, 2, 3, 4, 5, and 6 months, proceeding to the earlier time in sequence only when significant effects have been identified at each later time period. Changes from the baseline within each group are evaluated using paired t-tests. In addition, analysis of variance is performed on all baseline measurements and measurable subject characteristics to assess homogeneity between groups. All statistical procedures are conducted using the Statistical Analysis System (SAS Institute Inc., Cary, N.C.). An alpha level of 0.05 is used in all statistical tests.

An unexpected statistically significant improvement in the nutritional status of vitamin, mineral, and nutrient levels measured is observed in the treated subjects over the controls upon completion of the study. Specifically, homocysteine levels in women receiving supplements remain unelevated. Moreover, patients in the test group show statistically significant increased patient compliance with the compositions described herein over the compositions having the placebo dosage form having the greater volume of other commercially available prenatal vitamins and do not report significant adverse events. Therefore, the study confirms that oral administration of the compositions of the present disclosure is effective in improving the nutritional status of patients and increasing patient compliance. Other unexpected results the observation that the homocysteine levels in women receiving the supplements are not elevated, due to folic acid intake, leading to a better prognosis regarding risk of neural tube defects in their infants.

1. A composition for nutritional supplementation in a pregnant woman, a prenatal woman, or a woman who is breastfeeding, the composition consisting of:
vitamin B₉, vitamin B₁₂, vitamin B₆, vitamin D, iodine, iron, and one or more inactive ingredients;
wherein said composition is in an oral dosage form selected from the group consisting of caplets, tablets, lozenges, pills and capsules; and
wherein said composition has at least one of: a weight of about 70 mg to about 210 mg and a volume of about 0.150 cm³ to about 0.050 cm³.

2. The composition of claim 1, wherein the composition comprises about 0.5 mg to about 1.5 mg vitamin B₉, about 6 μg to about 18 μg vitamin B₁₂, about 1.2 mg to about 3.8 mg vitamin B₆, about 500 IU to about 1500 IU vitamin D, about 75 μg to about 225 μg iodine, and about 9 mg to about 27 mg iron.

3. The composition of claim 1, wherein the composition comprises about 1 mg vitamin B₉, about 12 μg vitamin B₁₂, about 2.5 mg vitamin B₆, about 1000 IU vitamin D, about 150 μg iodine, and about 18 mg iron.

4. The composition of claim 1, wherein the composition comprises at least about 1 mg vitamin B₉, at least about 12 μg vitamin B₁₂, at least about 2.5 mg vitamin B₆, at least about 1000 IU vitamin D, at least about 150 μg iodine, and at least about 18 mg iron.

5. (canceled)

6. The composition of claim 5, wherein the at least one inactive ingredient is a sweetener.

7. The composition of claim 1, wherein the oral dosage form is a tablet.

8. The composition of claim 7, wherein the tablet is a coated tablet.

9. (canceled)

10. The composition of claim 1, wherein the composition has a weight of about 100 mg to about 180 mg.

11. The composition of claim 1, wherein the composition has a weight of about 140 mg.

12. The composition of claim 1, wherein the composition has a weight of about 145 mg.

13. (canceled)

14. The composition of claim 1, wherein the composition has a volume of about 0.105 cm³.

15. The composition of claim 1, wherein the composition has a volume of less than about 0.105 cm³.

16. The composition of claim 1, wherein the composition is a prenatal vitamin or a dietary supplement.

17. A method comprising administering the composition of claim 1 to a patient.

18. The method of claim 17, wherein the composition comprises about 0.5 mg to about 1.5 mg vitamin B₉, about 6 μg to about 18 μg vitamin B₁₂, about 1.2 mg to about 3.8 mg vitamin B₆, about 500 IU to about 1500 IU vitamin D, about 75 μg to about 225 μg iodine, and about 9 mg to about 27 mg iron.

19. The method of claim 17, wherein the composition comprises about 1 mg vitamin B₉, about 12 μg vitamin B₁₂, about 2.5 mg vitamin B₆, about 1000 IU vitamin D, about 150 μg iodine, and about 18 mg iron.

20. The method of claim 17, wherein the composition comprises at least about 1 mg vitamin B₉, at least about 12 μg vitamin B₁₂, at least about 2.5 mg vitamin B₆, at least about 1000 IU vitamin D, at least about 150 μg iodine, and at least about 18 mg iron.

21. The method of claim 17, wherein the composition further comprises at least one inactive ingredient.

22. The method of claim 17, wherein the composition is a tablet.

23. The method of claim 17, wherein the composition is administered to a patient once daily.

24. The method of claim 17, wherein the composition has a weight of about 70 mg to about 210 mg.

25. The method of claim 17, wherein the composition has a weight of about 140 mg.

26. The method of claim 17, wherein the composition has a weight of about 145 mg.

27. The method of claim 17, wherein the composition has a volume of about 0.150 cm3 to about 0.050 cm³.

28. The method of claim 17, wherein the composition has a volume of about 0.105 cm³.

29. The method of claim 17, wherein the composition has a volume of less than about 0.105 cm³.

30. The method of claim 17, wherein the patient is a pregnant woman, prenatal woman, or a woman who is breast-feeding.
